(19) United States
(12) Patent Application Publication
(10) Pub. No.: US 2009/0319693 A1
(43) Pub. Date: Dec. 24, 2009

(54) METHOD AND APPARATUS FOR INTERFACING HOST DEVICE AND SLAVE DEVICE

(75) Inventor: Hyo-dae KIM, Yongin-si (KR)

Correspondence Address: SUGHRUE MION, PLLC, 2100 PENNSYLVANIA AVENUE, N.W., SUITE 800, WASHINGTON, DC, 20037, US

(73) Assignee: Samsung Electronics Co., Ltd., Suwon-si (KR)

(21) Appl. No.: 12/394,327

(22) Filed: Feb. 27, 2009

(30) Foreign Application Priority Data
Jun. 24, 2008 (KR) 10-2008-0059789

(51) Int. Cl. G06F 3/00

(52) U.S. Cl. 710/8; 710/19

(57) ABSTRACT

Provided is a method and an apparatus for interfacing between a host device and a slave device using a simple script. The method of interfacing a slave device communicably linked to a host device includes detecting whether a connection event with the host device is generated; storing current state information in a script file that is recognized by the host device if the connection event with the host device is generated; and transmitting the stored script information to the host device.

### CROSS-REFERENCE TO RELATED PATENT APPLICATION

This application claims priority from Korean Patent Application No. 10-2008-0059789, filed on Jun. 24, 2008, in the Korean Intellectual Property Office, the disclosure of which is incorporated herein by reference in its entirety.

### BACKGROUND OF THE INVENTION

1. Field of the Invention

Apparatuses and methods consistent with the present invention relate to an interface system between a host device and a slave device, and more particularly, to a method and apparatus for interfacing between a host device and a slave device, and a method thereof

2. Description of the Related Art

In general, mobile disk devices store various types of digital data such as still image data, moving image data, and voice data using a NAND type flash memory. In addition, the mobile disk devices are applied to mobile devices such as MP3 players and digital cameras.

When a mobile device, such as an MP3 player or a digital camera, is connected to a digital television (DTV) via a Universal Serial Bus (USB), the DTV generally recognizes the mobile device as a mobile disk device having a mass storage profile.

Thus, the DTV displays a root folder stored in the mobile device and reproduces contents found by user's navigation within the root folder.

For example, it is assumed that a user desires to reproduce contents included in a “Music/Classic/Bach” directory of an MP3 player connected to a DTV. Then, although the MP3 player is set to the directory, the DTV re-sets the directory of the MP3 player and browses from a top directory through a user interface. Here, the user should navigate through the “Music/Classic/Bach” directory displayed on a screen of the DTV and reproduce the contents included therein.

It is assumed that the user desires to reproduce contents included in an MP3 player in a home theater system (HTS). Then, unless user interface information is displayed on a front panel of the HTS, the DTV needs to be turned on. The user then navigates to a desired directory on the DTV and reproduces the contents.

Thus, when the user uses a mobile storage device, desired contents should be individually found from directories and reproduced, which is inconvenient for the user.

### SUMMARY OF THE INVENTION

The present invention provides a method and apparatus for device interfacing, which provides a user interface that is convenient for a user using a simple script recognized by a host device and a slave device.

According to an aspect of the present invention, there is provided a method of interfacing a slave device connected by wire or wirelessly to a host device, the method including: sensing whether a connection event with the host device is generated; storing current state information in a script file that is recognized by the host device when the connection event with the host device is generated; and transmitting the stored script information to the host device.

According to another aspect of the present invention, there is provided a method of interfacing a host device connected by wire or wirelessly to a slave device, the method including: checking whether script information exists in a directory that is accessible to the slave device when a connection event with the slave device is generated; and performing a corresponding reproduction function using device reproduction information existing in the script when the script information exists in the agreed directory.

According to another aspect of the present invention, there is provided an apparatus for interfacing a host device, the apparatus including: an interface unit which receives contents and script information from a slave device through a standard wired or wireless interface format; and a controller which determines whether script file information exists in a specific directory when a connection to the slave device is detected through the interface unit and performs a reproduction function using device reproduction information existing in the script when the script file information exists in the directory.

According to another aspect of the present invention, there is provided an apparatus for interfacing a slave device, the apparatus including: an interface unit which receives contents and script information from a slave device through a standard wired or wireless interface format; and a controller which generates a script file that is recognized by the host device when a connection to the host device is sensed through the interface unit, writes current state information as a script to the generated script file, and transmits the script to the host device.

### BRIEF DESCRIPTION OF THE DRAWINGS

The above and/or other aspects of the present invention will become more apparent by describing in detail exemplary embodiments thereof with reference to the attached drawings in which:

FIG. 1 shows a device interfacing system according to an exemplary embodiment of the present invention;

FIG. 2 is a block diagram of a host device of FIG. 1 according to an exemplary embodiment of the present invention;

FIG. 3 is a block diagram of a slave device of FIG. 1 according to an exemplary embodiment of the present invention;

FIG. 4 is a flowchart illustrating a method of interfacing a slave device according to an exemplary embodiment of the present invention; and

FIG. 5 is a flowchart illustrating a method of interfacing a host device according to an exemplary embodiment of the present invention.

### DETAILED DESCRIPTION OF EXEMPLARY EMBODIMENTS OF THE INVENTION

Hereinafter, the present invention will be described more fully with reference to the accompanying drawings, in which exemplary embodiments of the invention are shown.

FIG. 1 shows a device interfacing system according to an exemplary embodiment of the present invention.

Referring to FIG. 1, a host device 110 and a slave device 120 are connected to each other using a USB. Here, examples of the host device 110 may include a DTV, an HTS, a digital versatile disk (DVD) player, a personal computer (PC), and a printer. Further, examples of the slave device 120 may include an MP3 player, a USB memory stick, a digital camera, and a camcorder. Also, the connection between the host device 110 and the slave device 120 is not limited to the USB and may be set to various other wired and wireless interface formats. For example, the connection between the host device 110 and the slave device 120 may use an interface format of a mobile storage device such as IEEE 1394 and a wireless USB.

In addition, the host device 110 and the slave device 120 include a script profile that is recognized by both the host device 110 and the slave device 120.

When the slave device 120 is connected to the host device 110, the slave device 120 generates the script profile that is recognized by both the host device 110 and the slave device 120, stores current reproduction information in the generated script profile as a script, and transmits the script to the host device 110.

Also, when the slave device 120 is connected to the host device 110, the host device 110 determines whether the script profile information exists in a directory accessible to the slave device 120 (generally, a root directory) and performs a reproduction function using the current reproduction information existing in the script, when the script profile information exists in the directory.

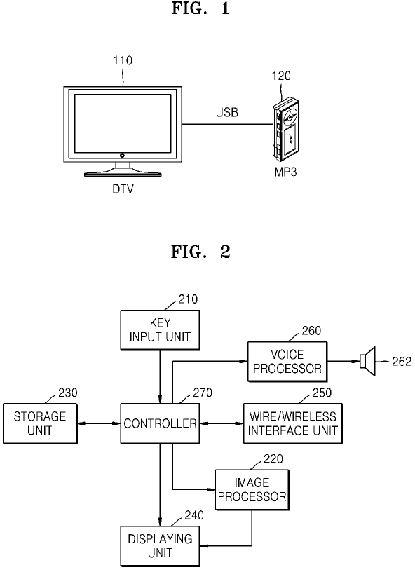

FIG. 2 is a block diagram of the host device 110 of FIG. 1 according to an exemplary embodiment of the present invention.

The host device 110 includes a key input unit 210, an image processor 220, a storage unit 230, a displaying unit 240, a wired/wireless interface unit 250, a voice processor 260, a controller 270.

The key input unit 210 inputs a user command through a plurality of key modules or touch screens.

The image processor 220 restores a compressed image signal to an original signal.

The storage unit 230 stores a control program operating the controller 270 formed of a flash memory or a hard disk drive, and various audio/video (A/V) contents.

The displaying unit 240 displays an image output from the image processor 220 in a frame unit and displays command information generated in the controller 270.

The wired/wireless interface unit 250 receives contents and script information from the slave device 120 through the standard wired/wireless interface format. Here, the standard wired/wireless interface format uses a USB interface or a wireless interface format.

The voice processor 260 restores a compressed voice signal to an original voice signal.

A speaker 262 reproduces a voice signal received from the voice processor 260 as a voice or sound.

When the slave device 120 is connected to the controller 270, the controller 270 installs the directory of the slave device 120 through the wired/wireless interface unit 250, determines whether the script profile information exists in the directory accessible to the slave device 120, determines whether the script profile information can be processed when the script profile information exists in the directory, and performs a reproduction function by using the current reproduction information contained in the script. In addition, the controller 270 outputs the contents or messages of the storage unit 230 to the image processor 220 and the voice processor 260 according to a specific reproduction command.

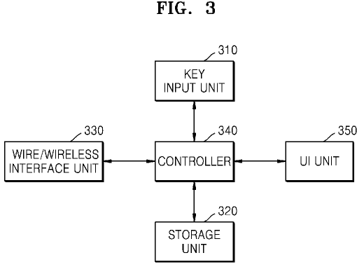

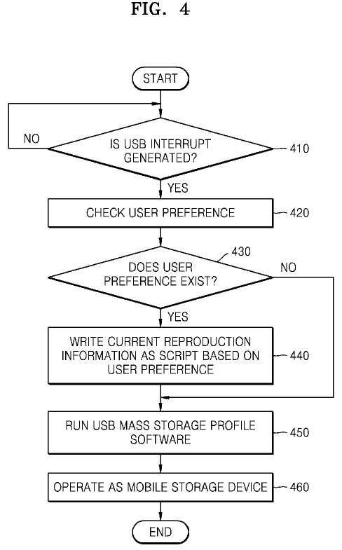

FIG. 3 is a block diagram of the slave device 120 of FIG. 1 according to an exemplary embodiment of the present invention.

The slave device 120 includes a key input unit 310, a storage unit 320, a wired/wireless interface unit 330, a controller 340, and a user interface (UI) unit 350.

The key input unit 310 inputs a user command through a plurality of key modules or touch screens.

The storage unit 320 stores a control program operating the controller 340 formed of a flash memory or a hard disk drive, and various A/V contents. In particular, the storage unit 320 stores a script file in which current reproduction information is written.

The wire/wireless interface unit 330 receives contents and script information from the slave device 120 through the standard wired/wireless interface format. Here, the standard wired/wireless interface format uses a USB interface or a wireless interface format.

The UI unit 350 designates a user preferred action to the script file.

The controller 340 senses a connection event with the host device 110 through the wire/wireless interface unit 330. When a connection event with the host device 110 is generated, the controller 340 detects the connection event and writes the current reproduction information to the script file recognized by the host device 110 according to the user preferred action designated in the UI unit 350 and transmits the written script file to the host device 110.

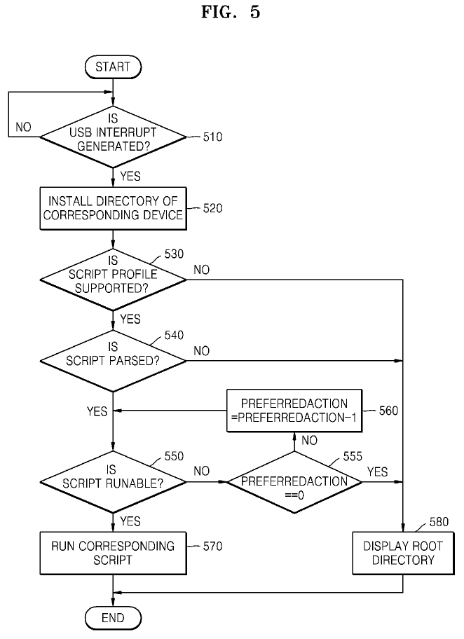

FIG. 4 is a flowchart illustrating a method of interfacing the slave device 120 according to an exemplary embodiment of the present invention.

The host device 110 and the slave device 120 include a script profile that is recognized by both the host device 110 and slave device 120.

In operation 410, when the slave device 120 is connected to the host device 110, the slave device 120 senses a connection event with the host device 110 by using a USB interrupt signal.

When the slave device 120 senses the connection event with the host device 110, the slave device 120 generates a script file that is recognized by the host device 110.

Then, in operation 420, the slave device 120 checks for a user preference set by a user.

Here, the user preference is set in advance by a user before connecting to the device through the user interface. For example, the user preference may be set to “view directory” or “reproduce current file”.

As another example, the user preference may be edited from a separate external device such as a PC and downloaded to the slave device 120.

In operation 430, the slave device 120 determines whether the user preference exists.

In operation 440, when the slave device determines that the user preference exists, the slave device 120 writes the current reproduction information and directory information to a simple script file based on the user preference. Here, the simple script is formed of a number of execute statements including data, definition statements, and commands. Also, the script is interpreted and executed by each one of the execute statements. In addition, the slave device 120 confirms the directory in which the script is stored with the host device 110.

Examples of the simple script are shown below.

```
# Simple Script Descriptor
# (Mandatory) Define Script Version, Current Version = 1.0
# This field is the only mandatory field in this simple script
    SimpleScriptVersion=1
# (Optional) Device Vendor
    DeviceVendor=Samsung
# (Optional) Device Name
    DeviceName=YP T-10
# (Optional) User Name
    UserName=Howard
# (Optional) Device Category
    DeviceCategory=MP3 Player
# (Optional) Device Icon Location
    DeviceIcon=/Image/Icon/ypt-10.jpg
# (Optional) Device Background Image Location
    BackgroundImage=/Image/Background/baby.jpg
# (Optional) Predetermined Directory
    Predetermined Directory=/Music
# (Optional) Predetermined File
    PredeterminedFile=/Music/sample.mp3
# (Optional) Predetermined Image Directory
    PredeterminedImageDirectory=/Image/Photo/MyBaby
# (Optional) Current Directory
    CurrentDirectory=/Music/Class/Bach
# (Optional) Current File
    CurrentFile= =/Music/Class/Bach/a-1.mp3
# (Optional) Current Play Time (hh:mm:ss)
# This field should be used with CurrentFile field
    CurrentTime=00:01:30
# (Optional) Preferred Action when it connects to host device
# 0 : Do not do anything (Normal Action)
# 10 : Change to PredeterminedDirectory
# 11 : Play PredeterminedFile
# 20 : Change to CurrentDirectory
# 21 : Play CurrentFile
# 22 : Play CurrentFile with CurrentTime
# 30 : Start slide show while playing PredeterminedFile
# If PreferredAction is not successful,
# the minor action will automatically try.
    PreferredAction=22
# (Optional) SlideShow Option - Image order
# This field is only valid when PreferredAction is 30
# 0 : Alphabetic
# 1 : Random
    SlideShowImageOrder=0
# # (Optional) SlideShow Option - Music order
# This field is only valid when PreferredAction is 30
# 0 : Alphabetic
# 1 : Random
    SlideShowMusicOrder=1
```

Here, “SimpleScriptVersion” is a field designed to manage a version of the script. All scripts have a lower compatibility.

Also, information that is familiar with the user is displayed through the user interface.

“DeviceIcon” is a field for device icons which are to be displayed on a screen.

“BackgroundImage” is a field for a background of a user preference UI.

“PredeterminedDirectory” is a field for selecting a user preference directory.

“PredeterminedFile” is a field for selecting a user preference song.

“PredeterminedImageDirectory” is a field for designating a user preference image directory.

“CurrentDirectory”, “CurrentFile”, and “CurrentTime” are fields for transmitting directories, files, time information that are currently used by the user.

“PreferredAction” is a field for designating a user preference action when the slave device is changed to a mobile storage device.

The slave device 120 may designate preference actions through the user interface before connecting to the host device 110. Here, when the host device 110 cannot perform a user desired action, the host device 110 automatically tries to perform a lower action of lower compatibility. Thus, when the host device 110 cannot perform a user's current desired action, the host device 110 identifies the next action and performs the lower action automatically.

“SlideShowImageOrder” is a field for designating a user desired slide show command.

“SlideShowMusicOrder” is a field for designating the order of background music of the user desired slide show.

The simple script files described above are automatically generated by the inner software.

As another example, the simple script files may be edited from an external device such as a PC and manually copied by the user to the slave device 120.

In addition, the simple script files may be transformed to structuralized Extensible Markup Language (XML).

Moreover, the simple script files may use a set file format along with other structuralized file formats.

The slave device 120 may only designate an index representing the script.

Referring back to FIG. 4, when writing of the script files is completed in operation 440 or when the slave device determines that the user preference does not exist in operation 430, software of a USB mass storage profile is executed and the current slave device 120 is changed to a USB mass storage mode, in operation 450.

Here, in the USB mass storage mode, the slave device 120 such as an MP3 player is connected to the host device 110 such as a TV through a USB port, and thus, the slave device 120 is used as a hard disk of the connected host device 110. That is, the host device 110 reads data directly from the slave device 120 as a hard disk.

Finally, the slave device 120 is operated as a mobile storage device, in operation 460.

FIG. 5 is a flowchart illustrating a method of interfacing the host device 110 according to an exemplary embodiment of the present invention.

In operation 510, when the slave device 120 is connected to the host device 110, the host device 110 senses a connection event with the slave device 120 by using a USB interrupt signal.

Then, in operation 520, when the host device 110 senses the connection event with the slave device 120, the host device 110 installs (e.g., downloads) directories included in the slave device 120 and generates new directories within the host device 110.

In operation 530, a host device 110 determines whether to support a script profile. For example, the host device 110 determines whether the script files exist in a specific directory accessible to the slave device 120 and determines whether to support the script profiles. Here, when it is determined that the host device 110 does not support the script profile, a root directory is displayed in operation 580.

Then, when it is determined that the host device 110 supports the script profile, the host device 110 determines whether the script files can be parsed in operation 540.

Here, when the script files cannot be parsed, the host device 110 displays the root directory in operation 580.

When the script files can be parsed, the host device 110 determines whether the script files can be run in operation 550.

Here, when the script files cannot be run, the host device 110 checks for a preferred action set by a user, in operation 555.

For example, it is assumed that a current preferred action in the script file is set to “22:Play Current File at Current Time”.

Here, when the preferred action is set to “0”, the host device 110 displays the root directory. Otherwise, a lower preferred action is set, instead of the current preferred action, in operation 560.

For example, when the preferred action “22:Play Current File at Current Time” cannot be run, the preferred action is set to the lower preferred action “21:Play Current File at Current Time”.

Thus, when the host device 110 cannot perform the desired action, the host device 110 automatically tries to perform the action lower than the current action so that the next action of the user can be known.

On the other hand, when the script can be run, the host device 110 performs a corresponding function using device reproduction information existing in the corresponding script, in operation 570.

For example, when the preferred action is set to “21:Play Current File at Current Time” in the script file, the host device 110 reproduces the contents file at the current time.

Also, when the preferred action is set to “20:Change to Current Directory” in the script file, the host device 110 displays directory information of current reproducing contents in the slave device 120.

In addition, when the preferred action is set to “10:Change to Predetermined Directory” in the script file, the host device 110 displays directory information of the contents selected by the user.

As described above, according to the exemplary embodiments of the present invention, when the slave device is connected to the host device, functions performed in the slave device can be directly performed in the host device using a simple script stored in the slave device. For example, a DTV can directly reproduce music reproduced in an MP3 player. Also, the DTV can directly display the directory in which contents of the MP3 player are stored.

The invention can also be embodied as computer readable codes on a computer readable recording medium. The computer readable recording medium is any data storage device that can store data which can be thereafter read by a computer system. Examples of the computer readable recording medium include read-only memory (ROM), random-access memory (RAM), CD-ROMs, magnetic tapes, floppy disks, and optical data storage devices. The computer readable recording medium can also be distributed over network coupled computer systems so that the computer readable code is stored and executed in a distributed fashion.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A method of interfacing a slave device communicably linked to a host device, the method comprising:
detecting whether a connection event with the host device is generated;
storing current state information as script information in a script file that is recognized by the host device if it detected that the connection event with the host device is generated; and
transmitting the stored script information to the host device.

2. The method of claim 1, further comprising setting a script profile that is recognized by the host device.

3. The method of claim 1, wherein the script information is formed of a number of execute statements, the execute statements comprising data, definition statements, and commands, and the script information being interpreted and executed by each one of the execute statements.

4. The method of claim 1, wherein the storing comprises:
checking user preferred information; and
writing current reproduction information to a simple script file based on the user preferred information if the user preferred information exists.

5. The method of claim 1, wherein the user preferred information is designated through a user interface.

6. The method of claim 1, wherein the user preferred information is edited by a separate external device and is downloaded.

7. The method of claim 1, wherein the storing comprises writing the information to a directory that is accessible to the host device.

8. The method of claim 1, wherein the storing further comprises designating user preference reproduction states.

9. The method of claim 1, wherein in the transmitting of the stored script information to the host device, the stored script information is transmitted to the host device according to a Universal Serial Bus (USB) mass storage profile.

10. A method of interfacing a host device communicably linked to a slave device, the method comprising:
determining whether script information exists in a directory that is accessible to the slave device if a connection event with the slave device is generated; and
performing a corresponding reproduction function using device reproduction information existing in the script information if the script information exists in the accessible directory.

11. The method of claim 10, wherein the determining whether script information exists comprises installing the directory of the slave device in the host device and detecting a script file in a specific directory.

12. The method of claim 10, wherein the performing the corresponding reproduction function comprises:
parsing script information; and
running the parsed script.

13. The method of claim 10, wherein in the performing the corresponding reproduction function, a device reproduction function corresponding to a designated preferred action is performed.

14. The method of claim 10, wherein in the performing the corresponding reproduction function, an action lower than a current action is performed if a designated preferred action cannot be performed by the host device.

15. An apparatus for interfacing a host device, the apparatus comprising:
an interface unit which receives contents and script information from a slave device through a standard wired or wireless interface format; and
a controller which determines whether script file information exists in a specific directory if a connection to the slave device is detected through the interface unit and performs a reproduction function using device reproduction information existing in the script file information if it is determined that the script file information exists in the directory.

16. The apparatus of claim 15, wherein the interface unit has a Universal Serial Bus (USB) or IEEE 1394 format.

17. An apparatus for interfacing a slave device, the apparatus comprising:
an interface unit which receives contents and script information from a slave device through a standard wired or wireless interface format; and
a controller which generates a script file that is recognized by the host device if a connection to the host device is detected through the interface unit, writes current state information as a script to the generated script file, and transmits the script to the host device.

18. The apparatus of claim 17, further comprising a user interface unit for designating a user preferred action to the script file.

19. The apparatus of claim 17, wherein the interface unit has a Universal Serial Bus (USB) or IEEE 1394 format.

20. A computer readable recording medium having embodied thereon a computer program for executing the method of claim 1.

21. A computer readable recording medium having embodied thereon a computer program for executing the method of claim 10.
